(19) United States
(12) Patent Application Publication
(10) Pub. No.: US 2019/0375946 A1
(43) Pub. Date: Dec. 12, 2019

(54) POLYMER DISPERSION

(71) Applicants: Agency for Science, Technology and Research, Singapore (SG); Nanyang Technological University, Singapore (SG); SkyCool Pte Ltd, Singapore (SG)

(72) Inventors: Satyasankar Jana, Singapore (SG); Man Pun Wan, Singapore (SG); Christopher Arthur Crawley, Singapore (SG); Satyananda Barik, Singapore (SG); Poh Zihan, Singapore (SG); Alexander Van Herk, Singapore (SG)

(21) Appl. No.: 16/476,926

(22) PCT Filed: Jan. 11, 2018
(86) PCT No.: PCT/SG2018/050015

§ 371 Date: Jul. 10, 2019

(30) Foreign Application Priority Data
Jan. 11, 2017 (SG) 10201700238P

(51) Int. Cl. C09D 5/33; C09D 7/40; C09D 133/12; C09D 133/16; C09D 7/20; B05D 5/06; B05D 5/08

(52) U.S. Cl. CPC C09D 5/004; C09D 7/70; C09D 133/12; B05D 5/083; C09D 7/20; B05D 5/063; C09D 133/16

(57) ABSTRACT

The present invention generally relates to a dispersion comprising a plurality of core-shell particles, wherein the core comprising non-fluorinated polymer and the shell comprises fluorinated polymer. It also relates to the use of the said dispersion as an additive in a coating formulation in at least 10 wt %, wherein substrates coated with said coating formulation exhibit improved solar-reflective and anti-dirt properties. In preferred embodiments, the said core comprises methyl methacrylate monomer and the said shell comprises hexafluorobutyl acrylate, hexafluorobutyl methacrylate, tridecafluorooctyl arylate or perfluorooctyl acrylate.

### TECHNICAL FIELD

The present invention generally relates to a dispersion comprising a plurality of core-shell particles in a solvent. The present invention also relates to the use of the dispersion comprising a plurality of core-shell particles as an additive in the coating formulation.

### BACKGROUND ART

Coatings having a high total solar reflectance (TSR) or albedo are useful, particularly to reduce the solar heat gain of a building when applied on the roof, in facades, window and sidings etc. To date, this type of coating is considered as one of the most useful “green” approaches applied for the modern buildings. Additionally, coatings with high reflective properties, particularly in the near infrared (NIR) region, are useful for myriads of applications such as in military and automobile as fire retardant or intumescent coating as well as in other infrastructure related applications.

Total solar reflectance (TSR) is defined as the fraction of incident solar energy, which includes UV, visible and near infrared (NIR) wavelengths of about 200 to about 2500 nm, reflected from a surface and is an important parameter of a coating to reduce the heat build-up beneath the surface. High TSR value of coatings offers potential for cooling energy saving of a building (by air conditioning) and therefore indirectly reduces CO₂ emission and extension of the coating life due to reduced rate of degradation of coating materials at lower temperature.

Recently, there has been a tremendous interest within the coating industries to produce coatings with high TSR value, which are frequently termed as, among others, “cool coatings”, “solar reflective coatings or “infrared reflective coatings”. Such coatings are typically applied outdoor for example on roof or façade. The TSR of a coating is by and large determined by reflection, refraction and diffraction and dependent on several parameters including particle size, refractive index of the binder and additive to the coatings.

However, the TSR value of a coating or coated surface is reduced over time as the dirt accumulates thereby causing reduced heat shielding properties of the coating or coated surface.

Therefore, there is a need to provide a coating or a coated surface that overcomes, or at least ameliorates, one or more of the disadvantages described above.

Coating and coated surface having enhanced of TSR and dirt-removal properties, which are capable of reducing the heat build-up of the coating or coated substrate, comprising fluorinated core-shell microparticle (CSMP) are disclosed herein.

### SUMMARY

According to one aspect, there is provided a dispersion comprising

a plurality of core-shell particles, wherein the core comprises at least one non-fluorinated polymer and the shell comprises at least one shell layer having at least one fluorinated polymer or fluorinated copolymer therein; and

a solvent;

wherein said dispersion has a solid content of the core-shell particles of at least 10 wt %

Advantageously, the core-shell microparticles present in the dispersion as described above may have a narrow size distribution and thus said microparticles may be of uniform size distribution. Further advantageously, the at least one fluorinated monomer may be available in a large quantity that renders the manufacturing process of the dispersion of the present invention cost-effective.

In another aspect, there is provided use of a dispersion comprising

a plurality of core-shell particles, wherein the core comprises at least one non-fluorinated polymer and the shell comprises at least one shell layer having at least one fluorinated polymer or fluorinated copolymer therein; and

a solvent;

wherein said dispersion has a solid content of the core-shell particles of at least 10 wt %, as an additive in a coating formulation.

Advantageously, the coating formulation resulted from the mixing of a coating material with the additive described herein may be stable for an extended period of time. Hence, when dispersed in a suitable solvent, the resulting dispersion may not undergo aggregation or coagulation. Yet advantageously, the dispersion of the present invention may be compatible with the water-based coating materials.

Further advantageously, the coating formulation described in the present invention exhibit better total solar reflectance (TSR) as compared to the commercially available cool coating, when applied onto a surface of a substrate. In addition, the coating formulation comprising the dispersion of the present invention advantageously may not be leached when applied onto the surface of a substrate.

In another aspect of the invention, there is provided a method of increasing total solar reflectance (TSR) of a substrate comprising the step of forming a coating of a mixture of a dispersion with a coating material on a surface of said substrate, wherein said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10% of the dispersion.

Advantageously, the substrate coated with the coating formulation of the present invention display improved total solar reflectance (TSR) as compared to the commercially available cool coating (in the absence of the dispersion of the present invention), when applied onto a surface. Yet advantageously, the coated substrate may also exhibit anti-dirt property owing to the presence of the omniphobic dispersion of the present invention. Therefore, advantageously the coated substrate above may exhibit dual functionality that is improved or enhanced TSR and anti-dirt properties.

In another aspect, there is provided a coated article comprising a layer of a dispersion coated thereon, said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10% of the dispersion.

Advantageously, the coating formulation, the coated substrate or the coated article is capable of reflecting solar light and repel dirt. This may be termed as “dual-functionality” where the coating formulation, the coated substrate or the coated article has two properties—that of total solar reflectance and anti-dirt capabilities. The total solar reflectance may be improved or enhanced as compared to a similar coating formulation but without the dispersion of the present application.

The coating formulation, coated substrate or coated article as defined in the present disclosure may have the dual-functionalities due to the presence of a methacylate functional group present in the at least one fluorinated polymer or fluorinated copolymer in at least one shell layer of the shell. The methacylate functional group may be part of a 2,2,3,4,4,4-Hexafluorobutyl Methacrylate monomer in the shell of the core-shell particle.

### Definitions

The following words and terms used herein shall have the meaning indicated:

“Alkyl” as a group or part of a group refers to a straight or branched aliphatic hydrocarbon group, preferably a C₁-C₅₀ alkyl, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

The term “anti-dirt” as used herein refers to the ability of a surface to repel dirt that may be organic and/or inorganic molecules. Such term therefore may encompass hydrophobicity, oleophobicity or both of these terms (which is then termed as omniphobicity). The surface having such property is therefore termed as being hydrophobic, oleophobic or omniphobic.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a dispersion comprising a plurality of core-shell particles and a solvent will now be disclosed.

The present invention provides a dispersion comprising

a. a plurality of core-shell particles, wherein the core comprises at least one non-fluorinated polymer and the shell comprises at least one shell layer having at least one fluorinated polymer or fluorinated copolymer therein; and

b. a solvent.

The plurality of core-shell particles of the above dispersion may comprise a core and at least one shell layer. Hence, it is to be understood that when more than one shell layer is present, the core-shell particles may thus comprise a core and multiple shell layers. As the name suggests, the structure of the plurality of core-shell particles defined herein may be formed when the surface of the core above is partially or completely encapsulated or enclosed by the shell layer. It is to be noted that a core-shell structure having the surface of the core fully enclosed by the shell layer is preferred.

The core of the plurality of core-shell particles described herein may comprise at least one non-fluorinated polymer. As defined herein, a person skilled in the art would understand that the core of the plurality of core-shell particles may thus be substantially free of fluorine or fluorinated polymer. Non-limiting examples of the at least one non-fluorinated polymer are the methacrylate- or acrylate-based polymers such as polymethyl methacrylate (PMMA), polymethacrylic acid (PMAA), polymethyl acrylate (PMA), polyacrylic acid (PAA), polyethyl methacrylate (PEMA), polyethyl acrylate (PEA), poly(n-propyl acrylate), polyacrylamide, polyacrylonitrile, or mixtures thereof. Further, polystyrene or styrenics polymers may also be used as the at least one non-fluorinated polymer.

As for the shell of the plurality of core-shell particles, the shell (or the shell layer) may comprise at least one fluorinated polymer. Therefore, it is to be understood that the shell may comprise a single fluorinated polymer, a combination of at least one fluorinated polymers and at least one non-fluorinated polymer or a combination of two or more fluorinated polymers. Non-limiting examples of such combination may include one fluorinated polymer and one non-fluorinated polymer, one fluorinated polymer and two non-fluorinated polymers (one being a first non-fluorinated polymer and another one being a second non-fluorinated polymer), two fluorinated polymers (one being a first fluorinated polymer and another one being a second fluorinated polymer) and two non-fluorinated polymers, and so forth. When the non-fluorinated polymer is absent, the shell may contain a combination of two, three, four, five or more fluorinated polymers. Combination of the polymers described above may be termed as polymer blend or polymer mixture.

The core and shell of the plurality of core-shell particles may also comprise a copolymer. Hence, when a copolymer is used, the core may comprise one copolymer of at least two non-fluorinated monomers. On the other hand, the shell may comprise one copolymer of at least two, three, four, or five fluorinated monomers, which optionally may further comprise at least one non-fluorinated monomer. The copolymer having at least two, three, four, or five fluorinated monomers may be found in the same or different shell layer. Similar as above, the copolymers described above may be also present as copolymer blend or copolymer mixture.

Non-limiting examples of the at least one fluorinated polymer include poly(2,2,2-Trifluoroethyl Acrylate), poly(2,2,2-Trifluoroethyl Methacrylate), poly(2,2,3,3-Tetrafluoropropyl Acrylate), poly(2,2,3,3-Tetrafluoropropyl Methacrylate), poly(2,2,2,3,3-Pentafluoropropyl Acrylate, poly(2,2,2,3,3-Pentafluoropropyl Methacrylate, poly(2,2,3,4,4,4-Hexafluorobutyl Acrylate), poly(2,2,3,4,4,4-Hexafluorobutyl Methacrylate), poly(2,2,3,3,4,4,4-Heptafluorobutyl Acrylate), poly(2,2,3,3,4,4,4-heptafluorobutyl Methacrylate), poly(2,2,3,3,4,4,5,5-Octafluoropentyl Acrylate), poly(2,2,3,3,4,4,5,5-Octafluoropentyl Methacrylate), poly(3,3,4,4,5,5,6,6,7,7,8,8,8-Tridecafluorooctyl Acrylate), poly(3,3,4,4,5,5,6,6,7,7,8,8,8-Tridecafluorooctyl Methacrylate), poly(1H,1H-Perfluorooctyl Acrylate), poly(1H,1H-Perfluorooctyl Methacrylate), poly(3,3,4,4,5,5,6,6,7,7,8,8,9,9,10,10,10-Heptadecafluorodecyl Acrylate), poly(3,3,4,4,5,5,6,6,7,7,8,8,9,9,9,10,10,10-Heptadecafluorodecyl Methacrylate), poly(3,3,4,4,5,5,6,6,7,7,8,8,9,9,10,10,11,11,12,12,12-Heneicosafluorododecyl Acrylate), poly(3,3,4,4,5,5,6,6,7,7,8,8,9,9,10,10,11,11,12,12,12-Heneicosafluorododecyl Methacrylate or mixtures thereof. In this regard, it is to be understood that any other fluoro-acrylates or fluoro-methacrylates, which are not listed above and their combinations may also be used as the at least one fluorinated polymer as defined above.

Non-limiting examples of the core-shell particles of the present invention include PMMA as the core particle and poly(2,2,3,4,4,4-Hexafluorobutyl Acrylate) as the shell particle, PMMA as the core particle and poly(2,2,3,4,4,4-Hexafluorobutyl Methacrylate) as the shell particle, PMMA as the core particle and poly(3,3,4,4,5,5,6,6,7,7,8,8,8-Tridecafluorooctyl Acrylate) as the shell particle, PMMA as the core particle and poly(1H,1H-Perfluorooctyl Acrylate) as the shell particle. When poly(3,3,4,4,5,5,6,6,7,7,8,8,8-Tridecafluorooctyl Acrylate) or poly(1H,1H-Perfluorooctyl Acrylate) is used as the shell particle, the polymer may be mixed with at least one fluorinated polymer, which may be different from poly(3,3,4,4,5,5,6,6,7,7,8,8,8-Tridecafluorooctyl Acrylate) or poly(1H,1H-Perfluorooctyl Acrylate). The non-limiting examples of such mixture of polymers include poly(2,2,3,4,4,4-Hexafluorobutyl Acrylate) mixed with poly(3,3,4,4,5,5,6,6,7,7,8,8,8-Tridecafluorooctyl Acrylate), or poly(2,2,3,4,4,4-Hexafluorobutyl Acrylate) mixed with poly(1H,1H-Perfluorooctyl Acrylate). Other combinations of polymers as defined above may also be used when appropriate.

The polymers in the form of blend or mixture as defined above may be present in the ratio of monomer in the range of about 10:1 to 1:1, such as about 9:1, about 8:1, about 7:1, about 6:1, about 5:1, about 4:1, about 3:1, about 2:1, 9:2, about 7:2, about 5:2, about 3:2, about 8:3, about 7:3, about 5:3, about 4:3, about 9:4, about 7:4, or about 5:4. Similarly, the ratio of fluorinated monomer may follow the ratio of monomer set forth above for example in the range of about 10:1 to 1:1, such as about 9:1, about 8:1, about 7:1, about 6:1, about 5:1, about 4:1, about 3:1, about 2:1, 9:2, about 7:2, about 5:2, about 3:2, about 8:3, about 7:3, about 5:3, about 4:3, about 9:4, about 7:4, or about 5:4. The preferred ratio of the two monomers may be about 9:1 or about 4:1. In a preferred embodiment, the monomers of 2,2,3,4,4,4-Hexafluorobutyl Acrylate and 3,3,4,4,5,5,6,6,7,7,8,8,8-Tridecafluorooctyl Acrylate may be present in the ratio of about 9:1, the monomers of 2,2,3,4,4,4-Hexafluorobutyl Acrylate and 1H,1H-Perfluorooctyl Acrylate may be present in the ratio of about 4:1. Therefore, it is to be understood that any two of the fluorinated polymers as defined above may also be combined with the ratio of monomer as defined herein.

The mixture described above may be present in the form of copolymer. Hence, for the examples shown above, the copolymers are copolymer of (2,2,3,4,4,4-Hexafluorobutyl Acrylate and 3,3,4,4,5,5,6,6,7,7,8,8,8-Tridecafluorooctyl Acrylate), or copolymer of (2,2,3,4,4,4-Hexafluorobutyl Acrylate and 1H,1H-Perfluorooctyl Acrylate). The copolymers described above may be termed as fluorinated copolymer of at least two fluorinated monomers. As mentioned above, the fluorinated copolymer may be found in the same shell layer.

The fluorinated polymer or fluorinated copolymer as defined above may comprise a fluoroalkyl monomer with at least one of an acrylate monomer or a methacrylate monomer, or mixtures thereof. The fluoroalkyl monomer above may have at least one fluorine atom therein and the length of the alkyl chain may be in the range of 2 to 20 carbon atoms, such as 2, 3, 4, 5, 6, 7, 8, 9, 10, 11, 12, 13, 14, 15, 16, 17, 18, 19 or 20 carbon atoms. Preferred fluoroalkyl monomer of the present invention may be fluoroalkyl monomer having 4 and 8 carbon atoms. The fluoroalkyl monomer may have fluorine atoms in the range of 1 to 30, such as 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 fluorine atoms.

The polymers, polymer combinations (or copolymers) present in both core and shell of the plurality of core-shell particles as defined above may be in the form of crystalline, semi-crystalline, amorphous polymer or mixture thereof. Further, the polymers or copolymers of both core and shell of the plurality of core-shell particles of the present invention may be isotactic, syndiotactic, atactic or eutactic.

The plurality of core-shell particles of the present invention may have an average particle size in the range of about 50 nm to 800 nm, about 50 nm to 100 nm, about 50 nm to 200 nm, about 50 nm to 400 nm, about 100 nm to 200 nm, about 100 nm to 400 nm, about 100 nm to 800 nm, about 200 nm to 220 nm, about 200 nm to 240 nm, about 200 nm to 260 nm, about 200 nm to 280 nm, about 200 nm to 300 nm, about 200 nm to 320 nm, about 200 nm to 340 nm, about 200 nm to 360 nm, about 200 nm to 380 nm, about 200 nm to 400 nm, about 200 nm to 800 nm, about 220 nm to 240 nm, about 220 nm to 260 nm, about 220 nm to 280 nm, about 220 nm to 300 nm, about 220 nm to 320 nm, about 220 nm to 340 nm, about 220 nm to 360 nm, about 220 nm to 380 nm, about 220 nm to 400 nm, about 220 nm to 800 nm, about 240 nm to 260 nm, about 240 nm to 280 nm, about 240 nm to 300 nm, about 240 nm to 320 nm, about 240 nm to 340 nm, about 240 nm to 360 nm, about 240 nm to 380 nm, about 240 nm to 400 nm, about 240 nm to 800 nm, about 260 nm to 280 nm, about 260 nm to 300 nm, about 260 nm to 320 nm, about 260 nm to 340 nm, about 260 nm to 360 nm, about 260 nm to 380 nm, about 260 nm to 400 nm, about 260 nm to 800 nm, about 280 nm to 400 nm, about 280 nm to 800 nm, about 300 nm to 400 nm, about 300 nm to 800 nm, about 360 nm to 400 nm, about 380 nm to 400 nm, or about 400 nm to 800 nm. The preferred average particle size of the core-shell particles may be in the range of about 200 nm to 210 nm, about 220 nm to 240 nm, about 250 nm to 270 nm, about 290 nm to 300 nm, about 300 nm to 320 nm, or about 340 nm to 360 nm.

The core-shell particles above may therefore be in micrometre or nanometre size range. Hence, such core-shell particles may be termed as core-shell nanoparticles (CSNPs) or core-shell microparticles (CSMPs).

The average particle size of the plurality of core-shell particles above may be determined by a suitable method such as dynamic light scattering, or imaging technique that may include transmission electron microscope (TEM) and scanning electron microscope (SEM). Other suitable techniques than mentioned above may be used when it is suitable. It is to be understood that the measurement techniques above may provide a slight difference in the determination of the average particle size of the plurality of core-shell particles.

Regardless of the measuring technique used, the average particle size of the plurality of core-shell particles may be uniform that is the particle size distribution of the plurality of core-shell particles may be narrow or substantially narrow. However, it is to be noted that the average particle size of the plurality of core-shell particles may also encompass the non-uniform particle size as long as the plurality of core-shell particles is capable of being well-mixed with another material such as a coating material.

The plurality of core-shell particles of the present invention may also be characterized by the thickness of the shell layer. Here, the average thickness of the shell layer of the plurality of core-shell particles may be in the range of about 5 nm to 50 nm such as about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, or about 50 nm. Further, it should be understood that the average thickness of the shell layer of the plurality of core-shell particles above should not be limited to the numbers recited above as long as the thickness falls between about 5 nm to 50 nm (including the end limits).

The method for determining the average particle size above may also be used to measure the thickness of the shell. Therefore, when the average particle size of the core-shell particles and the thickness of the shell are determined by using the method described above, the average particle size of the core may then be calculated or deduced accordingly.

The dispersion of the present invention may comprise at least two phases, solid phase and liquid phase. The solid content of the dispersion described herein may refer to the content of the core-shell particles in the dispersion, which may be defined in weight percent (wt %). The solid content of the dispersion described herein may be at least about 10 wt %, for example about 15 wt %, about 20 wt %, about 25 wt %, about 30 wt %, about 35 wt %, about 40 wt %, about 45 wt %, about 50 wt %, about 55 wt %, about 60 wt %, about 65 wt % or about 70 wt %. The preferred solid content of the dispersion may be about 40 wt %, about 45 wt %, about 46 wt %, about 47 wt %, about 50 wt %, about 55 wt %, or about 60 wt %. As defined above, it is to be understood that when the solid content of the dispersion is provided, the liquid content may refer to the remainder portion. For the sake of clarity, when the solid content of the dispersion is 55 wt %, the liquid content of the dispersion is 45 wt %.

As stated above, the solid content of the dispersion described herein may be adjusted accordingly for further use in various applications. In an embodiment, the dispersion described in the present invention may be used as an additive in a coating formulation. Hence, for such application, a higher solid content (typically more than 30 wt %) may be desirable.

The solvent present in the dispersion above may be a non-organic solvent or a mixture of two or more non-organic solvents. Such non-organic solvent may include water, inorganic salt solution, inorganic acid solution, inorganic base solution and inorganic buffer solution, which may be termed as an aqueous-based solvent or water-based solvent. It is to be noted that the type of solvents above is not limited and therefore may extend to other solvents that are not listed above as long as the solid phase as defined above is well-dispersed in the solvent. For the case where the solid phase comprises the core-shell particles as defined above, the core-shell particles may be dispersed in the aqueous-based solvent. In a preferred case, the core-shell particles as defined herein may be well-dispersed in the aqueous-based solvent.

Therefore, the present invention provides a dispersion comprising:

a. a plurality of core-shell particles, wherein the core comprises at least one non-fluorinated polymer and the shell comprises at least one shell layer having at least one fluorinated polymer or fluorinated copolymer therein; and

b. a solvent, wherein the solvent may be an aqueous-based solvent;

wherein the dispersion as defined herein has a solid content of the core-shell particles of at least 10 wt %.

Further, the present invention also provides a dispersion comprising:

a. a plurality of core-shell particles, wherein the core comprises at least one non-fluorinated polymer and the shell comprises at least one shell layer having at least one fluorinated polymer or fluorinated copolymer therein; and

b. a solvent, wherein the solvent may be an aqueous-based solvent;

wherein the dispersion as defined herein has a solid content of the core-shell particles of at least 20 wt %.

In addition, the present invention also provides a dispersion comprising:

a. a plurality of core-shell particles, wherein the core comprises at least one non-fluorinated polymer and the shell comprises at least one shell layer having at least one fluorinated polymer or fluorinated copolymer therein; and

b. a solvent, wherein the solvent may be an aqueous-based solvent;

wherein the dispersion as defined herein has a solid content of the core-shell particles of at least 30 wt %.

The dispersions of the present invention advantageously exhibit both hydrophobic and oleophobic properties. As demonstrated in the description and examples provided, when applied on a surface of a suitable substrate, the dispersion may show improved water contact angle suggesting that the dispersion may be hydrophobic. In addition, the dispersion of the present invention may also exhibit enhanced hexadecane contact angle indicating that the dispersion of the present invention may be oleophobic. When the dispersion exhibits hydrophobicity and oleophobicity, such dispersion may be termed as omniphobic. Therefore, it is to be understood that the dispersions of the present invention advantageously display enhanced hydrophobic and oleophobic properties, particularly when said dispersions are mixed with a coating material.

Exemplary, non-limiting embodiments of a method for preparing the dispersion comprising a plurality of core-shell particles and a solvent will now be disclosed.

The present invention provides a method for preparing the dispersion comprising a) a plurality of core-shell particles, wherein the core comprises at least one non-fluorinated polymer and the shell comprises at least one fluorinated polymer or fluorinated copolymer therein; and b) a solvent, wherein said dispersion has a solid content of at least 10%/o, at least 20%, or at least 30%.

The method described herein may be undertaken in a reaction chamber or reactor, thus advantageously avoiding the need for transferring the intermediates or the final product and therefore may potentially reduce the operating cost.

The method for preparing the above dispersion may comprise the steps of:

forming a core polymer by polymerization of the at least one non-fluorinated monomer in a solvent;

adding shell-forming fluorinated monomers or mixtures thereof to the core polymer obtained in step 1); and

polymerizing the shell-forming monomers in the mixture of step 2) to form the core-shell particles in the solvent.

The step of forming the core polymer as defined in step 1) above may be achieved via polymerization reaction known in the art such as via emulsion polymerization, solution polymerization, suspension polymerization, or precipitation polymerization. In a preferred embodiment, the step of forming the core polymer of step 1) may be undertaken via emulsion polymerization in presence or absence of surfactants.

The step of adding shell-forming fluorinated monomers or mixture (in presence or absence of surfactants) to the core polymer may be optionally followed by an equilibration stage for a period of time so as to allow a contact between the shell-forming fluorinated monomers or mixture with the surface of the core polymer. During the equilibration stage, essentially no polymerization of the shell monomers takes place.

The equilibration stage above may be undertaken in a period ranging from about one hour to 30 hours, such as about 2 hours, about 3 hours, about 4 hours, about 5 hours, about 6 hours, about 7 hours, about 8 hours, about 9 hours, about 10 hours, about 15 hours, about 20 hours, or about 25 hours.

Prior to adding the shell-forming monomer to the core polymer, the core polymer may be optionally subjected to a purification step, where undesired materials that may include unreacted core-forming monomers or side products are to be separated from the core polymer so as to minimize the amount of the impurity or undesired materials or products present in the core polymers. Alternatively, the shell-forming monomers may be added to the core polymer directly without having the core polymers purified.

The polymerization in step 1) and 3) may proceed via free-radical polymerization. Hence, it is to be understood that since essentially no polymerization takes place in step 2, therefore free-radical polymerization may not occur in step 2). The free-radical polymerization described in the present invention may proceed via emulsion polymerization, which may be undertaken in the presence of a starter or an initiator such as persulfates (or peroxysulfates) or water-soluble azo initiators. Non-limiting examples of such persulfates include sodium peroxomonosulfate, potassium peroxymonosulfate, sodium persulfate (or sodium peroxydisulfate), ammonium persulfate (ammonium peroxydisulfate), potassium persulfate (or potassium peroxydisulfate), 4,4′-Azobis(4-cyanovaleric acid), 2,2′-Azobis[2-(2-imidazolin-2-yl)propane]dihydrochloride, 2,2′-Azobis(2-methylpropionamidine)dihydrochloride, 2,2′-Azobis[N-(2-carboxyethyl)-2-methylpropionamidine]tetrahydrate, 2,2′-Azobis[2-(2-imidazolin-2-yl)propane], 2,2′-Azobis[2-methyl-N-(2-hydroxyethyl)propionamide], or mixtures thereof.

The above polymerization may proceed in the absence of surfactants, polymerizable surfactants (or surfmers) or stabilizers. Therefore, advantageously the polymerization process described herein may ease the operation when scaled up thereby rendering lower production costs.

The method of preparing the dispersion of the present invention may be undertaken in a reactor with a capacity in the range of few millilitres (such as 2 mL, 3 mL, 4 mL, 5 mL, 10 mL, 50 mL, 100 mL, 500 mL) to several litres (such as 1 L, 2 L, 3 L, 4 L, 5 L, 6 L, 7 L, 8 L, 9 L or 10 L). Such reactor may be operated in a batch, continuous or semi-batch process. The process of preparing the dispersion above may be undertaken in one reactor or multiple reactors. Such reactors may be equipped with inlets that allow the introduction of the starting materials (such as monomers and initiators) as well as solvent(s). Ideally, the reactor may also be equipped with a stirrer system and a thermo managing system. The stirrer system may facilitate the formation of substantially homogenous phase of the reaction mixture during the reaction in order to minimize the mass transfer resistance. The thermo managing system may be used to ensure that the reaction proceeds under a controlled temperature. The reactor may be optionally equipped with one or more gas inlets to allow the introduction of gases. This is particularly useful, when the process requires to be undertaken in an environment that is substantially free of oxygen.

The rotating speed of the stirrer may be in the range of about 100 rpm to about 1000 rpm such as about 200 rpm, about 300 rpm, about 400 rpm, about 500 rpm, about 600 rpm, about 700 rpm, about 800 rpm, or about 900 rpm. The temperature of the reactor, which is controlled by the thermo managing system, may be adjusted from about 40° C. to about 85° C., such as about 45° C., about 50° C., about 55° C., about 60° C., about 65° C., about 75° C., about 80° C., or about 85° C.

Since the shell-forming monomers may not well adhere to the core particle, a slow polymerization process of the shell-forming monomers may be desirable so as to prevent the homonucleation of the shell-forming monomer which will result in the formation of the particles without the core.

When the core-particles are formed in the solvent, the process of preparing the dispersion described herein may further comprise adjusting the amount of the solvent present to afford a dispersion with a desired solid content. The step of adjusting the amount of the solvent may be undertaken using heat treatment method such as evaporation. It is to be understood that the example provided here is not limiting and therefore other suitable techniques capable of reducing the liquid content (or increasing the solid content) of the dispersion may also be employed.

Further, the present disclosure also provides the method for preparing the dispersion as defined herein that may comprise the steps of:

forming a core polymer by polymerization of the at least one non-fluorinated monomer in a solvent;

adding shell-forming fluorinated monomers or mixtures thereof to the core polymer obtained in step 1);

polymerizing the shell-forming monomers in the mixture of step 2) to form the core-shell particles in the solvent or dispersion; and

concentrating the dispersion obtained in step 3) to a higher solid content as desired by an evaporative drying method, if needed.

Exemplary, non-limiting embodiments of the use of a dispersion comprising core-shell particles and a solvent as an additive in a coating formulation will now be disclosed.

The present invention provides use of a dispersion comprising:

a. a plurality of core-shell particles, wherein the core comprises at least one non-fluorinated polymer and the shell comprises at least one shell layer having at least one fluorinated polymer or fluorinated copolymer therein; and

b. a solvent;

wherein said dispersion has a solid content of the core-shell particles of at least 10%, as an additive in a coating formulation. The solid content above may be similar to the previously-described solid content. The preferred solid content of the core-shell particles may be at least 10%, at least 20% or at least 30%.

The plurality of core-shell particles of the dispersion for use as an additive in a coating formulation above may be similar as previously described, that is comprising a core and at least one shell layer. A person skilled will understand that when more than one shell layer is present, the core-shell particles may thus comprise a core and multiple shell layers. The plurality of core-shell particles defined herein may be formed when the surface of the core above is partially or completely encapsulated or enclosed by the shell layer. It is to be noted that a core-shell structure with the surface of the core fully enclosed by the shell layer is preferred.

The core of the plurality of core-shell particles described herein may comprise at least one non-fluorinated polymer. As defined herein, a person skilled in the art would understand that the core of the plurality of core-shell particles may thus be substantially free of fluorine or fluorinated polymer. Non-limiting examples of the at least one non-fluorinated polymer are the methacrylate- or acrylate-based polymers such as polymethyl methacrylate (PMMA), polymethacrylic acid (PMAA), polymethyl acrylate (PMA), polyacrylic acid (PAA), polyethyl methacrylate (PEMA), polyethyl acrylate (PEA), poly(n-propyl acrylate), polyacrylamide, polyacrylonitrile, or mixtures thereof. Similar as above, polystyrene or styrenics polymers may also be used as the at least one non-fluorinated polymer.

As for the shell of the plurality of core-shell particles, the shell (or the shell layer) may comprise at least one fluorinated polymer. Therefore, it is to be understood that the shell may comprise a single fluorinated polymer, a combination of at least one fluorinated polymers and at least one non-fluorinated polymer or a combination of two or more fluorinated polymers. Non-limiting examples of such combination may include one fluorinated polymer and one non-fluorinated polymer, one fluorinated polymer and two non-fluorinated polymers (one being a first non-fluorinated polymer and another one being a second non-fluorinated polymer), two fluorinated polymers (one being a first fluorinated polymer and another one being a second fluorinated polymer) and two non-fluorinated polymers, and so forth. When the non-fluorinated polymer is absent, the shell may contain a combination of two, three, four, five or more fluorinated polymers. Combination of the polymers described above may be termed as polymer blend or polymer mixture.

The core and shell of the plurality of core-shell particles may also comprise a copolymer. Hence, when a copolymer is used, the core may comprise one copolymer of at least two non-fluorinated monomers. On the other hand, the shell may comprise one copolymer of at least two, three, four, or five fluorinated monomers, which optionally may further comprise at least one non-fluorinated monomer. The copolymer having at least two, three, four, or five fluorinated monomers may be found in the same or different shell layer. Similar as above, the copolymers described above may be also present as copolymer blend or copolymer mixture.

Non-limiting examples of the at least one fluorinated polymer include poly(2,2,2-Trifluoroethyl Acrylate), poly(2,2,2-Trifluoroethyl Methacrylate), poly(2,2,3,3-Tetrafluoropropyl Acrylate), poly(2,2,3,3-Tetrafluoropropyl Methacrylate), poly(2,2,2,3,3-Pentafluoropropyl Acrylate, poly(2,2,2,3,3-Pentafluoropropyl Methacrylate, poly(2,2,3,4,4,4-Hexafluorobutyl Acrylate), poly(2,2,3,4,4,4-Hexafluorobutyl Methacrylate), poly(2,2,3,3,4,4,4-Heptafluorobutyl Acrylate), poly(2,2,3,3,4,4,4-Heptafluorobutyl Methacrylate), poly(2,2,3,3,4,4,5,5-Octafluoropentyl Acrylate), poly(2,2,3,3,4,4,5,5-Octafluoropentyl Methacrylate), poly(3,3,4,4,5,5,6,6,7,7,8,8,8-Tridecafluorooctyl Acrylate), poly(3,3,4,4,5,5,6,6,7,7,8,8,8-Tridecafluorooctyl Methacrylate), poly(1H,1H-Perfluorooctyl Acrylate), poly(1H,1H-Perfluorooctyl Methacrylate), poly(3,3,4,4,5,5,6,6,7,7,8,8,9,9,10,10,10-Heptadecafluorodecyl Acrylate), poly(3,3,4,4,5,5,6,6,7,7,8,8,9,9,9,10,10,10-Heptadecafluorodecyl Methacrylate), poly(3,3,4,4,5,5,6,6,7,7,8,8,9,9,10,10,11,11,12,12,12-Heneicosafluorododecyl Acrylate), poly(3,3,4,4,5,5,6,6,7,7,8,8,9,9,10,10,11,11,12,12,12-Heneicosafluorododecyl Methacrylate or mixtures thereof. In this regard, it is to be understood that any other fluoro-acrylates or fluoro-methacrylates, which are not listed above and their combinations may also be used as the at least one fluorinated polymer as defined above.

Non-limiting examples of the core-shell particles of the present invention include PMMA as the core particle and poly(2,2,3,4,4,4-Hexafluorobutyl Acrylate) as the shell particle, PMMA as the core particle and poly(2,2,3,4,4,4-Hexafluorobutyl Methacrylate) as the shell particle, PMMA as the core particle and poly(3,3,4,4,5,5,6,6,7,7,8,8,8-Tridecafluorooctyl Acrylate) as the shell particle, or PMMA as the core particle and poly(1H,1H-Perfluorooctyl Acrylate) as the shell particle. When poly(3,3,4,4,5,5,6,6,7,7,8,8,8-Tridecafluorooctyl Acrylate) or poly(1H,1H-Perfluorooctyl Acrylate) is used as the shell particle, the polymer may be mixed with at least one fluorinated polymer, which may be different from poly(3,3,4,4,5,5,6,6,7,7,8,8,8-Tridecafluorooctyl Acrylate) or poly(1H,1H-Perfluorooctyl Acrylate). The non-limiting examples of such mixture of polymers include poly(2,2,3,4,4,4-Hexafluorobutyl Acrylate) mixed with poly(3,3,4,4,5,5,6,6,7,7,8,8,8-Tridecafluorooctyl Acrylate), or poly(2,2,3,4,4,4-Hexafluorobutyl Acrylate) mixed with poly(1H,1H-Perfluorooctyl Acrylate). Other combinations of polymers as defined above may also be used when appropriate.

The polymers in the form of blend or mixture as defined above may be present in the ratio of monomer in the range of about 10:1 to 1:1, such as about 9:1, about 8:1, about 7:1, about 6:1, about 5:1, about 4:1, about 3:1, about 2:1, 9:2, about 7:2, about 5:2, about 3:2, about 8:3, about 7:3, about 5:3, about 4:3, about 9:4, about 7:4, or about 5:4. Similarly, the ratio of fluorinated monomer may follow the ratio of monomer set forth above for example in the range of about 10:1 to 1:1, such as about 9:1, about 8:1, about 7:1, about 6:1, about 5:1, about 4:1, about 3:1, about 2:1, 9:2, about 7:2, about 5:2, about 3:2, about 8:3, about 7:3, about 5:3, about 4:3, about 9:4, about 7:4, or about 5:4. The preferred ratio of the two monomers may be about 9:1 or about 4:1. In a preferred embodiment, the monomers of 2,2,3,4,4,4-Hexafluorobutyl Acrylate and 3,3,4,4,5,5,6,6,7,7,8,8,8-Tridecafluorooctyl Acrylate may be present in the ratio of about 9:1, the monomers of 2,2,3,4,4,4-Hexafluorobutyl Acrylate and 1H,1H-Perfluorooctyl Acrylate may be present in the ratio of about 4:1. Therefore, it is to be understood that any two of the fluorinated polymers as defined above may also be combined with the ratio of monomer as defined herein.

The mixture described above may be present in the form of copolymer. Hence, for the examples shown above, the copolymers are copolymer of (2,2,3,4,4,4-Hexafluorobutyl Acrylate and 3,3,4,4,5,5,6,6,7,7,8,8,8-Tridecafluorooctyl Acrylate), or copolymer of (2,2,3,4,4,4-Hexafluorobutyl Acrylate and 1H,1H-Perfluorooctyl Acrylate). The copolymers described above may be termed as fluorinated copolymer of at least two fluorinated monomers. As aforementioned above, the fluorinated copolymer may be found in the same shell layer.

The fluorinated polymer or fluorinated copolymer as defined above may comprise a fluoroalkyl monomer with at least one of an acrylate monomer or a methacrylate monomer, or mixtures thereof. The fluoroalkyl monomer above may have at least one fluorine atom therein and the length of the alkyl chain may be in the range of 2 to 20 carbon atoms, such as 2, 3, 4, 5, 6, 7, 8, 9, 10, 11, 12, 13, 14, 15, 16, 17, 18, 19 or 20 carbon atoms. Preferred fluoroalkyl monomer of the present invention may be fluoroalkyl monomer having 4 and 8 carbon atoms. The number of fluorine atom in the fluoroalkyl monomer may have fluorine atoms in the range of 1 to 30, such as 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 fluorine atoms.

The polymers, polymer combinations (or copolymers) present in both core and shell of the plurality of core-shell particles as defined above may be in the form of crystalline, semi-crystalline, amorphous polymer or mixture thereof. Further, the polymers or copolymers of both core and shell of the plurality of core-shell particles of the present invention may be isotactic, syndiotactic, atactic or eutactic.

The plurality of core-shell particles of the present invention may have the average particle size in the range of about 50 nm to 800 nm, about 50 nm to 100 nm, about 50 nm to 200 nm, about 50 nm to 400 nm, about 100 nm to 200 nm, about 100 nm to 400 nm, about 100 nm to 800 nm, about 200 nm to 220 nm, about 200 nm to 240 nm, about 200 nm to 260 nm, about 200 nm to 280 nm, about 200 nm to 300 nm, about 200 nm to 320 nm, about 200 nm to 340 nm, about 200 nm to 360 nm, about 200 nm to 380 nm, about 200 nm to 400 nm, about 200 nm to 800 nm, about 220 nm to 240 nm, about 220 nm to 260 nm, about 220 nm to 280 nm, about 220 nm to 300 nm, about 220 nm to 320 nm, about 220 nm to 340 nm, about 220 nm to 360 nm, about 220 nm to 380 nm, about 220 nm to 400 nm, about 220 nm to 800 nm, about 240 nm to 260 nm, about 240 nm to 280 nm, about 240 nm to 300 nm, about 240 nm to 320 nm, about 240 nm to 340 nm, about 240 nm to 360 nm, about 240 nm to 380 nm, about 240 nm to 400 nm, about 240 nm to 800 nm, about 260 nm to 280 nm, about 260 nm to 300 nm, about 260 nm to 320 nm, about 260 nm to 340 nm, about 260 nm to 360 nm, about 260 nm to 380 nm, about 260 nm to 400 nm, about 260 nm to 800 nm, about 280 nm to 400 nm, about 280 nm to 800 nm, about 300 nm to 400 nm, about 300 nm to 800 nm, about 360 nm to 400 nm, about 380 nm to 400 nm, or about 400 nm to 800 nm. The preferred average particle size of the core-shell particles may be in the range of about 200 nm to 210 nm, about 220 nm to 240 nm, about 250 nm to 270 nm, about 290 nm to 300 nm, about 300 nm to 320 nm, or about 340 nm to 360 nm.

The core-shell particles as defined herein may therefore be in micrometre or nanometre size range. Hence, such core-shell particles may be termed as core-shell nanoparticles (CSNPs) or core-shell microparticles (CSMPs).

The average particle size of the plurality of core-shell particles above may be determined by a suitable method such as dynamic light scattering, or imaging technique that may include transmission electron microscope (TEM) and scanning electron microscope (SEM). Other suitable techniques than mentioned above may be used when it is suitable. It is to be understood that the measurement techniques above may provide a slight difference in the determination of the average particle size of the plurality of core-shell particles.

The average particle size of the plurality of core-shell particles may be uniform, that is, the particle size distribution of the plurality of core-shell particles may be narrow or substantially narrow. However, it is to be noted that the average particle size of the plurality of core-shell particles may also be non-uniform provided that the plurality of core-shell particles is capable of being well-mixed with another material such as a coating material.

The plurality of core-shell particles of the present invention may also be characterized by the thickness of the shell layer. Here, the average thickness of the shell layer of the plurality of core-shell particles may be in the range of about 5 nm to 50 nm such as about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, about 49 nm, or about 50 nm. Further, it should be understood that the average thickness of the shell layer of the plurality of core-shell particles above should not be limited to the numbers recited above as long as it is in between about 5 nm to 50 nm.

The method for determining the average particle size above may also be used to measure the thickness of the shell. Therefore, when the average particle size of the core-shell particles and the thickness of the shell are determined by using the method described above, the average particle size of the core may then be calculated or deduced accordingly.

The dispersion for use as an additive in a coating formulation of the present invention may comprise at least two phases, solid phase and liquid phase. The solid content of the dispersion described herein may refer to the content of the core-shell particles in the dispersion, which may be defined in weight percent (wt %). The solid content of the dispersion described herein may be at least about 10%, for example about 15 wt %, about 20 wt %, about 25 wt %, about 30 wt %, about 35 wt %, about 40 wt %, about 45 wt %, about 50 wt %, about 55 wt %, about 60 wt %, about 65 wt % or about 70 wt %. The preferred solid content of the dispersion may be about 40 wt %, about 45 wt %, about 46 wt %, about 47 wt %, about 50 wt %, about 55 wt %, and about 60 wt %. As defined above, it is to be understood that when the solid content of the dispersion is provided, the liquid content may refer to the remainder portion. For the sake of clarity, when the solid content of the dispersion is 55 wt %, the liquid content of the dispersion is 45 wt %.

As stated above, the solid content of the dispersion for use as an additive in a coating formulation described herein may be adjusted, for example to a higher solid content (typically more than 30 wt %) so as to facilitate the mixing with coating materials.

The solvent present in the dispersion for use as an additive in a coating formulation above may be a non-organic solvent (or aqueous-based solvent) or a mixture of two or more non-organic solvents (or aqueous-based solvents). Such non-organic solvent may include water, inorganic salt solution, inorganic acid solution, inorganic base solution and inorganic buffer solution, which may be termed as an aqueous-based solvent or water-based solvent. It is to be noted that the type of solvents above is not limited and therefore may extend to other solvents that are not listed above as long as the solid phase as defined above is well-dispersed in the solvent. For the case where the solid phase comprises the core-shell particles as defined above, the core-shell particles may be dispersed in the aqueous-based solvent. In a preferred case, the core-shell particles may be well-dispersed in the aqueous-based solvent.

The present invention also provides a dispersion for use as an additive in a coating formulation comprising

a. a plurality of core-shell particles, wherein the core comprises at least one non-fluorinated polymer and the shell comprises at least one shell layer having at least one fluorinated polymer or fluorinated copolymer therein; and

b. a solvent, wherein the solvent may be an aqueous-based solvent;

wherein the above dispersion has a solid content of the core-shell particles of at least 10%, at least 20%, at least 30 wt %, or in the range of 35 wt % to 60 wt %. Other suitable solid content and its ranges thereof as previously defined may also be used when appropriate.

Exemplary, non-limiting embodiments of use of a method for increasing total solar reflectance (TSR) of a substrate will now be disclosed.

The present invention provides a method of increasing total solar reflectance (TSR) of a substrate comprising the step of forming a coating of a mixture of a dispersion with a coating material on a surface of said substrate, wherein said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10 wt % of the dispersion.

The present disclosure also provides a method of increasing total solar reflectance (TSR) of a substrate comprising the step of forming a coating of a mixture of a dispersion with a coating material on a surface of said substrate, wherein said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 20 wt % or at least 30 wt % of the dispersion.

The dispersion as defined herein may be the same dispersion as mentioned above. Therefore, it is to be understood that the characteristics of such dispersion such as the solid content, the dimension of the core-shell particles as well as the materials forming the core and shell layer(s) may be identical to those described in the previous section. Similarly, the at least one fluorinated polymer or fluorinated copolymer may be fluorinated polymer or fluorinated copolymer as defined above.

The coating formulation described herein may comprise the dispersion of the present invention and a coating material. The coating material used may include those coating materials that are commercially available and therefore are not limited as long as the coating materials are substantially compatible with the dispersion of the present invention. The non-limiting examples of the commercially available coating material include acrylic-based coatings and non-acrylate water based coating material. Such coating material is generally considered as aqueous-based coating and therefore may be compatible with the dispersion of the present invention.

Substrate to be coated by the above coating formulation may be selected from glass, metal sheet, alloy (such as steel), and composites thereof.

The dispersion as defined herein may be mixed with the coating material in the ratio of 10:90 to 70:30 being the ratio of dispersion and the coating material. Such ratio may be 10:90, 20:80, 25:75, 30:70, 35:75, 40:60, 45:55, 50:50, 60:40 or 70:30.

The mixture of the coating material and the dispersion of the present invention may then be applied on a surface of the substrate using known coating method such as spraying. It is to be understood that the coating method here is not limited to spraying, and therefore it may extend to drop casting or brushing as well.

When a spray painting technique is used, the coating (as a primary or as a top layer over other coat) may have a thickness in the range of about 50 to 500 μm, such as about 50 to 100 μm, about 50 to 200 μm, about 50 to 300 μm, about 50 to 400 μm, about 100 to 200 μm, about 100 to 300 μm, about 100 to 400 μm, about 100 to 500 μm, about 200 to 300 μm, about 200 to 400 μm, about 200 to 500 μm, about 300 to 400 μm, about 300 to 500 μm, or about 400 to 500 μm.

The coating formulation comprising the inventive dispersion of the present invention may be applied as a single layer coating or as a top layer coating. For the first single layer coating, the substrate may be coated only by the coating formulation comprising the dispersion of the present invention and there is essentially no other coating material applied before or after applying of such coating formulation comprising the dispersion described in the present invention. However, for the top layer coating, the substrate may be coated by the coating material first, which may be selected from the commercially available coating materials as defined herein to form a first coating layer having a certain thickness, followed by coating the first coating layer with the coating formulation comprising the dispersion of the present invention to form a second coating layer. Both methods described herein may result in an increase of the reflectance or total solar reflectance of the coated substrate.

There is thus also provided a coated article comprising a layer of a dispersion coated thereon, said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10% of the dispersion.

The method of increasing total solar reflectance (TSR) of a substrate as defined above may further comprise the step of heat treating the coating. The heat treating may be undertaken in one or more heat treating steps. During the heat treatment, the coated substrate may be placed in a chamber equipped with a thermo managing system, which allows the temperature of the chamber to be adjusted. Accordingly, the heat treating step may be undertaken under constant or variable temperature. When the variable temperature is used, the heat treating step may be undertaken with the temperature that is varied over time. Hence, when a two-step heat treating is used, the first heat treating step may be undertaken in a constant temperature such as at room temperature that is in the range from about 20 to 30° C. The temperature of the first step of heat treating may be then termed as a first temperature. The second step may involve an annealing process undertaken at temperature in the range of about 40 to 80° C., such as about 45° C., about 50° C., about 55° C., about 60° C., about 65° C., about 70° C., or about 75° C. The second step defined above is optional and therefore may be undertaken when it is necessary. In the absence of the second step, the step of heat treating the coating may therefore involve the first step alone, which may be undertaken at the same temperature as above (room temperature or any of the temperature within the range above).

The CSMP modified commercial coating exhibits omniphobicity that facilitates the dirt-removal. This may be particularly useful for “cool coatings” to retain “cool” properties of the coating in long run. Interestingly, the coated substrate above may also advantageously exhibit improved total solar reflectance (TSR) in comparison to the pure commercial coating. The higher TSR reduce the heat build-up of the substrate on which it is applied and, therefore, enhance “cool” properties of the coating. More importantly, the coated substrate comprising the dispersion of the present invention may exhibit dual functionality that is to concurrently exhibit the higher solar/IR reflective and anti-dirt properties.

The coating formulation, the coated substrate or the coated article may be capable of reflecting solar light and repel dirt. This may be termed as “dual-functionality” where the coating formulation, the coated substrate or the coated article has two properties—that of total solar reflectance and anti-dirt capabilities. The total solar reflectance may be improved or enhanced as compared to a similar coating formulation but without the dispersion of the present application. The coating formulation, coated substrate or coated article as defined in the present disclosure may have the dual-functionalities due to the presence of a methacylate functional group present in the at least one fluorinated polymer or fluorinated copolymer in at least one shell layer of the shell. The methacylate functional group may be part of a 2,2,3,4,4,4-Hexafluorobutyl Methacrylate monomer in the shell of the core-shell particle.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a number of scanning electron microscopy (SEM) images. FIG. 1a is the SEM image of the core particles prepared according to Example 1; FIG. 1b is the SEM image of the core-shell particles prepared according to Example 1. The scale bar on both images is 1 μm.

FIG. 2 is a number of transmission electron microscopy (TEM) images. FIG. 2a is the TEM image of the core particles prepared according to Example 1; FIG. 2b is the TEM image of the core-shell particles prepared according to Example 1. The scale bar on both images is 100 nm.

FIG. 3 is a number of images shown to measure the water contact angle. FIG. 3a is the image of the water contact angle of the core particles prepared according to Example 1; FIG. 3b is the image of the water contact angle of the core-shell particles prepared according to Example 1.

FIG. 4 is a schematic diagram of the coating procedure of CSMP modified commercial coatings (CCs) for characterization purposes.

FIG. 5 is a number of SEM images. FIG. 5a is the SEM image of the pure commercial coating, CC (no dispersion of Example 1 added) with a magnification of 5,000×; FIG. 5b is the SEM image of the mixture prepared according to Example 2 (with 10% of CS4 in the dispersion) with a magnification of 10,000×; FIG. 5c is the SEM image of the mixture prepared according to Example 2 (with 20% of CS4 in the dispersion) with a magnification of 10,000×; FIG. 5d is the SEM image of the mixture prepared according to Example 2 (with 40% of CS4 in the dispersion) with a magnification of 10,000×.

FIG. 6 is a number of graphs comparing the contact angle of the CC and CSMP modified CC single layer film (CSMP content is 40% w/w in dry film) based on the measurement of the contact angle described in Example 3. FIG. 6a is the water contact angle of CC and CSMP modified CCs before and after annealing; FIG. 6b is the hexadecane contact angle of CC and CSMP modified CCs before and after annealing.

FIG. 7 is a number of images related to the experiment according to Example 4. FIG. 7A is the image of UV/Vis/NIR Spectrometer (360 degree contour measurement) used for TSR measurements; FIG. 7B is a schematic diagram of an experimental set-up used for heat build-up measurement of the coatings.

FIG. 8 is a number of graphs showing the overlay percent reflectivity plot of commercial coating (CC) and CSMP modified CCs using single layer of coating described in Example 4a. FIG. 8a is the overlay percent reflectivity plot of CC and CC+CS1; FIG. 8b is the overlay percent reflectivity plot of CC and CC+CS4.

FIG. 9 is bar diagrams showing total solar reflectivity (TSR) commercial coating (CC) and CSMP modified CCs as well as the surface temperature of commercial coating (CC) and CSMP modified CCs using single layer of coating described in Example 4a. FIG. 9a is the histogram comparing TSR of CC and CSMP modified CCs; FIG. 9b is the histogram comparing the bottom surface temperature of commercial coating (CC) and CSMP modified CCs.

FIG. 10 is a number of graphs showing the overlay percent reflectivity plot of commercial coating (CC) and CSMP modified CCs as well as the surface temperature of commercial coating (CC) and CSMP modified CCs using top layer approach of coating as described in Example 4b. FIG. 10a is the overlay percent reflectivity plot of CC and CC+CS3; FIG. 10b is the histogram comparing TSR of CC and CSMP modified CCs with CSMP modified CCs as the top layer; FIG. 10c is the histogram comparing the bottom surface temperature of commercial coating (CC) and CSMP modified CCs with CSMP modified CCs as the top layer; FIG. 10d is a schematic diagram describing the refraction and diffraction due to the mismatch of the refractive index (RI) between matrix and CSMPs as described in Example 4b.

FIG. 11 is a number of drawings related to the experiment described in Example 5. FIG. 11a describes the general schematic diagram of the experimental procedure to measure anti-dirt properties described in Examples 5a and 5b; FIG. 11b depicts the experimental set-up for dirt wash-off in Example 5b.

FIG. 12 is a number of graphs describing the results of dirt-recovery of the commercial coating (CC) and CSMP modified CCs as described in Examples 5a and 5b. FIG. 12a is the overlay TSR vs. various reflectance plot of CC, CC+CS2, and CC+CS4 before dirt loading, after dirt loading by wet method and after dirt wash-off experiment; FIG. 12b is the histogram comparing reflectivity recovery after wash-off experiment for CC, CC+CS2, and CC+CS4.

FIG. 13 is a histogram comparing the heat build-up of the commercial coating (CC) and CSMP modified CCs as described in Example 5b, before and after wash off experiments.

FIG. 14 is a schematic diagram of the experimental set-up of dry dirt deposition described in Example 6a.

FIG. 15 is a number of graphs describing the results of wash-off of the dry soiled coupons as described in Example 6b. FIG. 15a is the overlay TSR vs. various reflectance plot of CC, CC+CS2, and CC+CS4 before dirt loading, after dirt loading by wet method and after dirt wash-off experiment; FIG. 15b is the histogram comparing reflectivity recovery of washing for CC, CC+CS2, and CC+CS4.

### DETAILED DESCRIPTION OF DRAWINGS

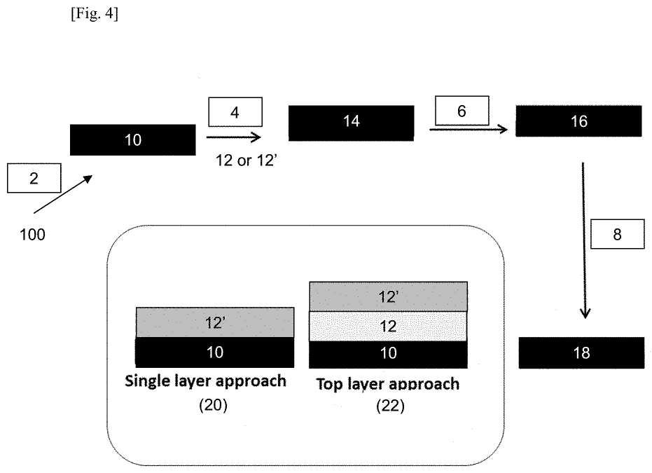

Referring to FIG. 4, there is provided a schematic diagram showing a process 100 of coating a substrate with CSMP modified commercial coating or commercial coating. In step 2, there is provided a substrate 10. In step 4, a commercial coating 12 or CSMP modified commercial coating 12′ is applied to substrate 10 to afford wet coating film 14. In step 6, a drying temperature is applied to dry the coating from the wet coating film 14 to the dry coating film 16 for a period of time sufficient to dry the coating. The drying temperature may be at ambient temperature and the period of drying may be in the range of one day to 10 days. The dry coating film 16 may optionally undergo annealing process at an annealing temperature for a suitable period of time to afford annealed coating film 18. The annealing temperature may be in the range from 40° C. to 60° C. The suitable annealing duration may be from one day to 10 days.

For a single layer coating method, substrate 10 is coated by CSMP modified commercial coating 12′ following the process 100 and the configuration is denoted as 20 in FIG. 4. As for top layer approach, commercial coating 12 is applied to substrate 10 following the process 100 above, followed by a second process 100, in which CSMP modified commercial coating 12′ is coated on the previously coated substrate and such configuration is denoted as 22 in FIG. 4.

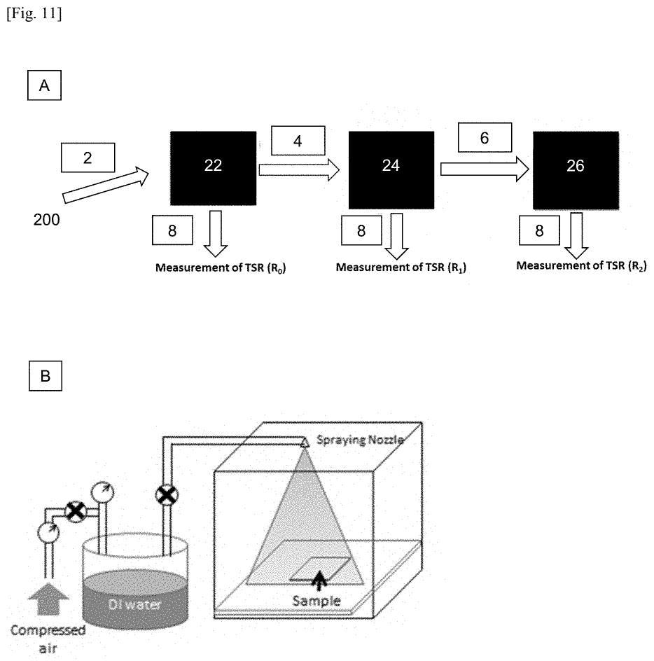

Referring to FIG. 11A, there is provided a schematic diagram showing a process 200 for analysing the anti-dirt properties of the substrate coated with CSMP modified commercial coating or commercial coating. In step 2, there is provided a coated substrate 22. In step 4, the deposition of dirt or soiling is undertaken to afford soiled substrate 24. In step 6, a wash-off or dirt-removal step is performed to afford washed substrate 26. Coated substrate 22, soiled substrate 24 and washed substrate 26 are then subjected to total solar reflectance (TSR) measurement experiment of step 8.

### EXAMPLES

Non-limiting examples of the invention and a comparative example will be further described in greater detail by reference to specific Examples, which should not be construed as in any way limiting the scope of the invention.

### Example 1: Preparation of Core-Shell Microparticle (CSMP) Dispersions

The polymerization of methyl methacrylate was undertaken in a 1 L-reactor under nitrogen equipped with mechanical stirrer. The reactor was deoxygenated prior to use by charging the reactor with a continuous flow of nitrogen. 80 mL of methyl methacrylate was introduced into the deoxygenated reactor containing 800 mL of deionized water (degassed by nitrogen) with a stirring rate of 200 rpm to form an oil-in-water suspension. The suspension was then heated to about 70° C. for a 30 minute equilibration time. 10 mL of aqueous solution of ammonium persulfate (APS, 0.682 grams, purchased from Sigma-Aldrich of St. Louis, Mo. of the United States of America) was added into the heated suspension. The resulting mixture changed its colour from semi-transparent to opaque-white colour after about two hours. After about 6-8 hours, the reactor was cooled to ambient temperature while stirring.

Without further purification, 11.12 g of fluoro monomer (2,2,3,4,4,4-hexafluorobutyl methacrylate or 6FBMA, purchased from Apollo Scientific of Cheshire of the United Kingdom) was added to the as-prepared PMMA dispersion with a solid content of about 10% at room temperature. The mixture was further stirred for 18 hours. The mixture was then heated to 70° C. and an aqueous solution of ammonium persulfate (0.107 g) was injected into the heated mixture to trigger the polymerization. The polymerization was continued for 8 hours. The reaction mixture was cooled down and transferred to a 2 L glass petri dish to increase the solid content by heating the content at 40° C. under a blow of air with continuous stirring. The final solid content of the dispersion in the reaction mixture after evaporation was about 45%.

The fluoropolymer content of the resulting particles was determined by proton NMR in CDCl₃. It had been found that the fluoropolymer content with respect to PMMA core was 12.8 wt %. The particle size of the PMMA is in the range from 280 to 360 nm in diameter with the shell thickness (made of fluoropolymer) of about 10 to 15 nm. Further, the experiments revealed that the concentrated of CSMPs are shown to be stable for months without any aggregation or coagulation.

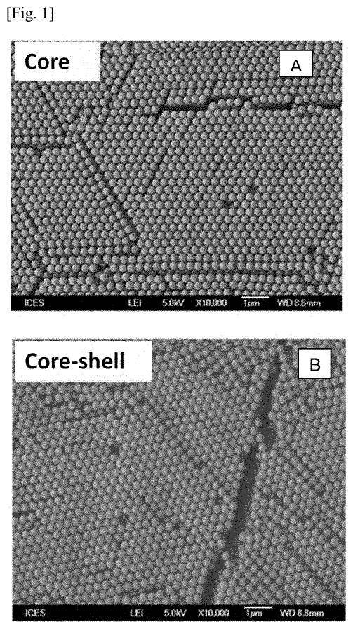

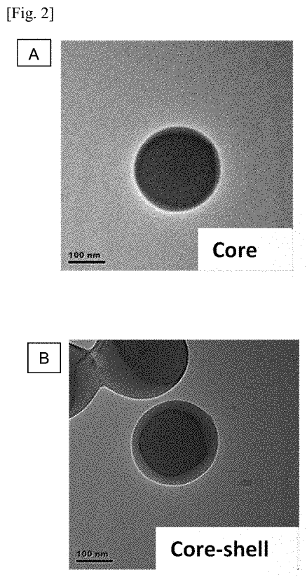

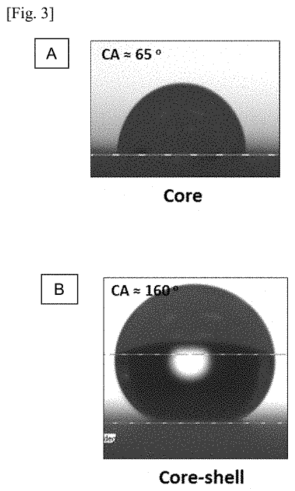

In addition, the core-shell microparticles dispersions were characterized by dynamic light scattering (DLS), scanning electron microscopy (SEM, as shown in FIG. 1), transmission electron microscopy (TEM as shown in FIG. 2), contact angle measurements (FIG. 3). The SEM, TEM and contact angle analysis for the core particles are shown in FIGS. 1a, 2a, and 3a, respectively. The SEM, TEM and contact angle analysis for the core-shell particles above are shown in FIGS. 1b, 2b, and 3b, respectively.

The characteristics of the various CSMP with different shell compositions were prepared and they are termed as CS1, CS2, CS3, and CS4, respectively (refer to Table 1).

TABLE 1
The dispersion comprises the polymer of methyl methacrylate in the core and the
fluorinated polymer in the shell layer.

| | | | | Z-Ave DLS | Z-Ave DLS | Average | Average |
|---|---|---|---|---|---|---|---|
| | | | Solid | core | core-shell | particle size - | shell |
| CSMP | Core- | Shell- | Content | particle size | particle size | TEM | thickness |
| Dispersion | monomer | monomer | (%) | (nm) | (nm) | (nm) | (nm) |
| Core | MMA | — | 46 | 305 | — | 203 | — |
| CS1 | MMA | 6FBA | 47 | 290 | 314 | 230 | 10 |
| CS2 | MMA | 6FBMA | 45 | 293 | 302 | 230 | 15 |
| CS3 | MMA | 6FBA:13FOA | 46 | 266 | 293 | 237 | 10 |
| | | (9:1) | | | | | |
| CS4 | MMA | 6FBA:15FOA | 45 | 306 | 356 | 255 | 15 |
| | | (8:2) | | | | | |

MMA = Methyl methacrylate (purchased from Sigma-Aldrich of St. Louis, Missouri of the United States of America)
6FBA = 2,2,3,4,4,4-Hexafluorobutyl Acrylate (purchased from Sigma-Aldrich of St. Louis, Missouri of the United States of America)
6FBMA = 2,2,3,4,4,4-Hexafluorobutyl Methacrylate (purchased from Apollo Scientific of Cheshire of the United Kingdom)
13FOA = 3,3,4,4,5,5,6,6,7,7,8,8,8-Tridecafluorooctyl Acrylate (purchased from Sigma-Aldrich of St. Louis, Missouri of the United States of America)
15FOA = 1H,1H-Perfluorooctyl Acrylate (purchased from Apollo Scientific of Cheshire of the United Kingdom)

Further information on the analytical instruments used throughout the Examples is as follow:

SEM images were obtained using JEOL JSM-6700F Field Emission SEM with Oxford INCA Energy Dispersive X-ray Spectrometer, JEOL USA, Inc. of Peabody, Mass. of the United States of America.

TEM images were obtained using Tecnai TF 20 S-twin with Lorentz Lens, FEI Company of Oregon of the United States of America.

DLS measurement was undertaken using Malvern Zetasizer Nano ZS, Malvern Instruments Ltd of Malvern of the United Kingdom.

### Example 2: Preparation of the CSMP Modified Coating and the Coated Surface

Compatibility of the additive comprising the dispersion prepared according to Example 1 to the parent coating material was tested to determine whether the additive of Example 1 can be successfully used in real application. The water-based CSMP dispersions obtained in Example 1 were slowly added to commercial water-based acrylic coating (termed as commercial coating or CC, supplied by SkyCool Pte Ltd of Singapore) with stirring (200-300 rpm) and upon visual inspection, it appeared to be well compatible with CC during or after mixing. The resulting mixture, which is referred as CSMP modified CC, remained homogeneous without any phase separation or coagulation for an extended period of time.

Various CSMP modified CC, with different shell compositions as termed as CS1, CS2, CS3, and CS4, respectively, were produced via mixing the CSMP with CC. The resulting CSMP modified CCs are then termed as CC+CS1, CC+CS2, CC+CS3, and CC+CS4, respectively.

The CSMP modified CCs were sprayed over 6.5×6.5 cm2 steel plates by a spray gun (purchased from BADGER Air Brush Model 100, Badger Air-Brush Co. of Illinois of the United States of America.) The coating process of FIG. 4 was used whereby the substrate 10 was the steel plate, the coating was either 12′ (CSMP modified CC) or 12 (commercial coating) as the first coating layer and 12′ as the second coating layer, the temperature used in step 6 to dry the wet coating film 14 was about 23° C. for 3 days. The dried coating film 16 was then annealed in step 8 at 40° C. for 7 days to give annealed coating film 18. The thickness of the coating was 100 to 400 μm. The range of thickness here refers to the thickness of the dried films. The configuration of the coated substrate for single layer approach is denoted as 20 in FIG. 4. The configuration of the coated substrate for the top layer approach is denoted as 22 in FIG. 4.

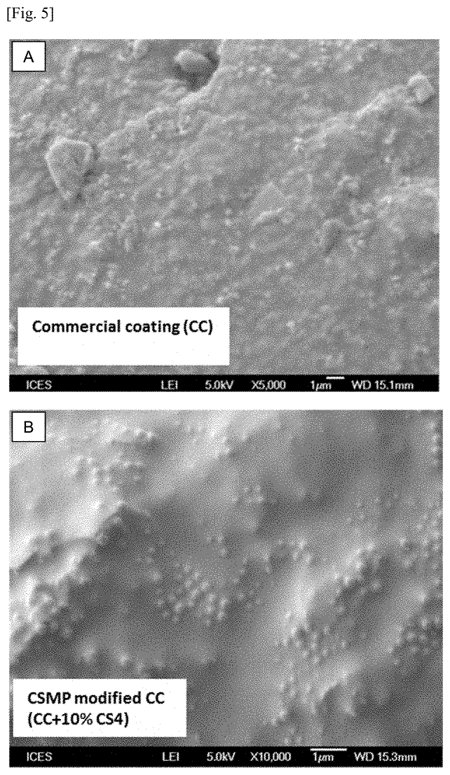

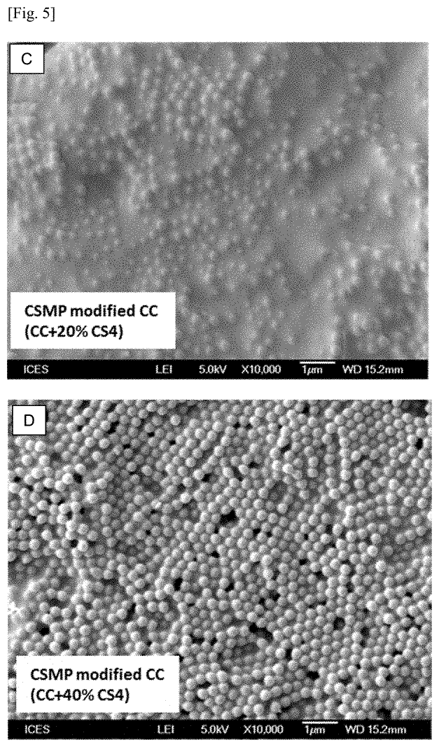

The thickness of the coating layer or coating film was measured by Elcometer 456 dual FNF thickness gauze, Model B (purchased from Elcometer Inc. of Michigan of the United States of America). The coated films (having dispersion with the amount of CS4 varied from 0 to 40%) were then analysed by SEM (refer to FIGS. 5a to 5d). Upon visual inspection and based on the surface roughness measurement, in general, the CSMP modified CC films were smoother in appearance. Further, the microparticles appear to be well dispersed in the coated film without any aggregation (refer to FIGS. 5b to 5d).

The smoothness of the CSMP modified CCs is likely the result of the filling up of peaks and troughs due to the presence of other irregular shaped additives of the coating by regular shaped CSMPs. Further, it is to be noted that the surface roughness caused by the addition of CSMPs are in nanometre range and therefore does not interfere the actual roughness of the material as observed by virtual inspection or the roughness measurement by any instrumental techniques (in micrometre range).

### Example 3: Water and Hexadecane Contact Angles Measurement

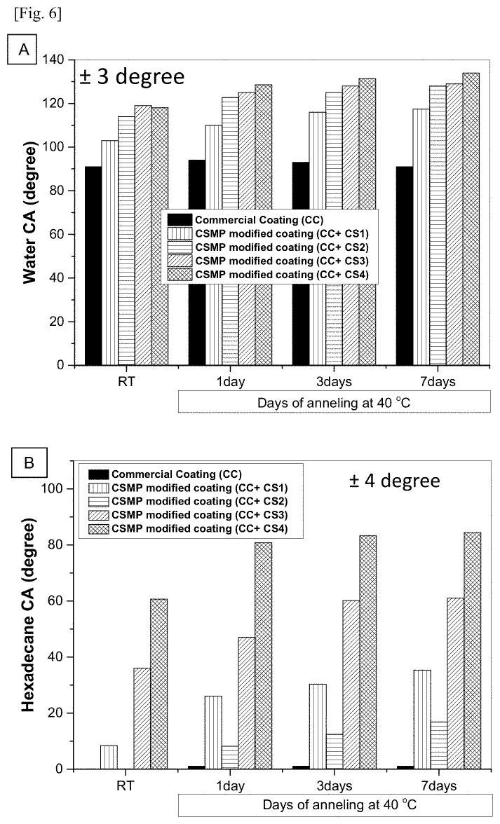

The annealed coated plates obtained in Example 2 were subjected to the contact angle analysis. The measurement of the water and hexadecane contact angles was undertaken separately. The result for water contact angle measurement will indicate the level of hydrophobicity of the coating, while the hexadecane contact angle will provide information on the degree of oleophobicity of the coating. The results shown in FIG. 6 suggest the omniphobic nature of the CSMP modified CCs. In general, the introduction of the CSMP additives significantly enhanced water contact angle and drastically improved hexadecane contact angle (refer to FIGS. 6a and 6b, respectively). More surprisingly, annealing of CSMP modified CCs resulted in the increase of both water and hexadecane contact angles which is most likely due to the stratification to afford more fluorinated CSMPs present at the surface of the film. The increase in contact angles is dependent on the duration of annealing. However, the experimental result suggest that no further increase was observed after three days (refer to both FIGS. 6a and 6b).

### Example 4: Solar Reflectivity and Heat Build-Up Measurement of CSMP Modified CCs

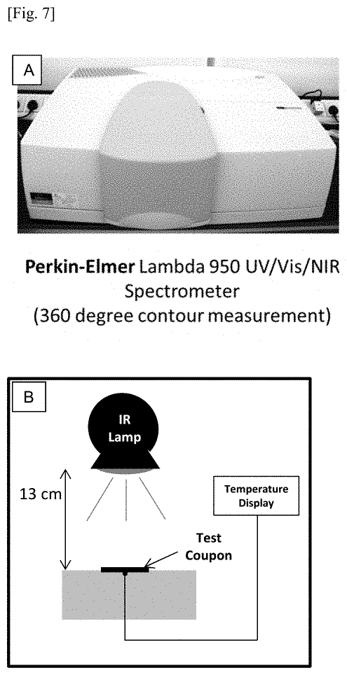

The CSMP modified coated steel coupons with the controlled thickness obtained in Example 2 were used for the solar reactivity and heat build-up measurements. TSR analysis was carried out using a UV/vis/NIR spectrometer (Perkin-Elmer Lambda 950 Spectrometer of San Diego of the United States of America) as shown in FIG. 7A. The in house set-up of the experiment is shown in FIG. 7b. In this example, there are two approaches adopted, the first one is via application of single layer of CSMP modified CC coating and the second one is via top layer approach by applying a thin layer of CSMP modified CC coating over CC coating.

The surface (bottom) temperature of the coated steel coupons was measured using the infrared (IR) lamp set-up as shown in FIG. 7b The equilibrium was attained in the range of about 4 to 8 minutes.

a. Single Layer Coating

Total Solar Reflectance (TSR) and heat build-up measurements were first performed using coupons coated with single layer of CSMP modified CC of about 100-400 μm. A graph showing the relationship between reflectivity and wavelength in the range of solar spectrum was then obtained. TSR values of coating films of similar thickness were compared as it is well known to have the coating thickness effect on TSR (<400 μm) and this is presented in Table 2.

TABLE 2
The variation of TSR and surface temperature with the coating
thickness and various inventive dispersion of the present
invention when single layer coating method was used

| | Average | Average | |
|---|---|---|---|
| | thickness of | Total Solar | Surface |
| | coating film | Reflectivity | temperature |
| Sample | (μm) | (TSR) | (° C.) |
| No coating (only steel | — | — | 93.3 ± 0.1 |
| coupon used as substrate) | | | |
| Steel coupon coated with | 110 | 0.795 | 76.2 ± 0.2 |
| CC | | | |
| Steel coupon coated with | 260 | 0.799 | — |
| CC | | | |
| Steel coupon coated with | 400 | 0.809 | 71.8 ± 0.5 |
| CC | | | |
| Steel coupon coated with | 110 | 0.831 | 67.9 ± 0.2 |
| CC + CS1 | | | |
| Steel coupon coated with | 110 | 0.806 | 69.9 ± 0.4 |
| CC + CS2 | | | |
| Steel coupon coated with | 110 | 0.811 | 64.0 ± 0.1 |
| CC + CS3 | | | |
| Steel coupon coated with | 120 | 0.82 | 67.7 ± 0.5 |
| CC + CS4 | | | |

The Commercial coating (CC), which is deemed to have a high-reflective roof cool coating, was used as a control. The experimental results suggest that all CSMP modified CCs (using four different CSMPs) display higher solar reflectivity than the pure CC. The absolute amount of increase in TSR is, albeit being low, still significant by considering the fact that the concentration of the active ingredient such as TiO₂ and silica microsphere present in CC was reduced to about 60 wt % of its original amount in the CSMP modified CC and yet still shows increase in reflectivity. This is surprising as in general, a person skilled in the art would expect that a reduction in the reflectivity would be observed as the concentration of the TiO₂ is decreased.

In addition, by comparing the thickness of the coating used, only one-quarter thickness of the CSMP modified CC films (versus that of the pure CC) were required to produce similar, if not slightly better, results in reflectivity. This has major implications, particularly when one considers reducing the amount of the coating material and thus the cost of the coating materials.

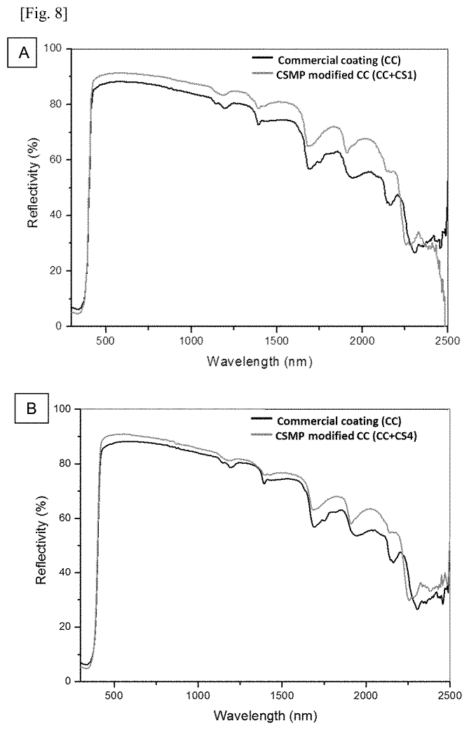

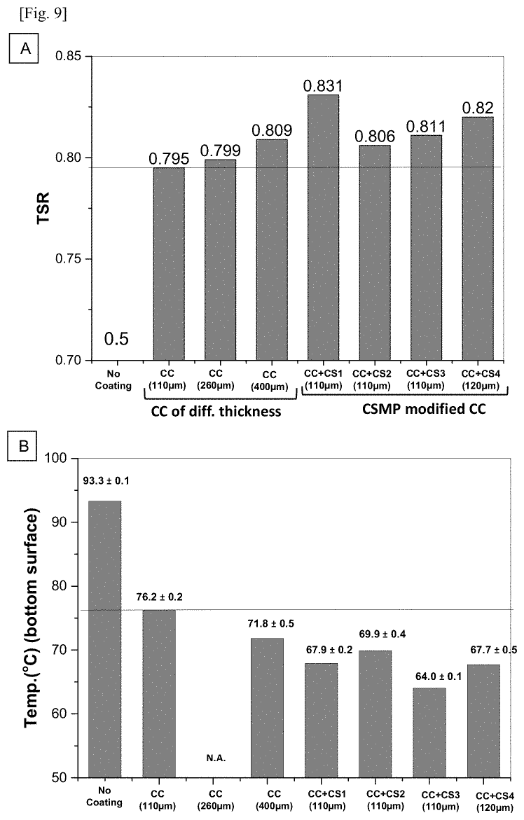

The above was further confirmed by the overlay reflectivity plots of CC vs. CSMP modified CCs (refer to FIGS. 8a and 8b) showing that the reflectivity of CSMP modified CCs is generally higher in mostly visible and near infrared regions than CC. The histogram shown in FIG. 9a. confirms similar observations. The comparison of the surface (bottom) temperature is depicted in FIG. 9b indicating that the bottom surface temperature of the CSMP modified CCs has a lower heat build-up property in comparison with the commercial coating.

b. Top Layer Approach

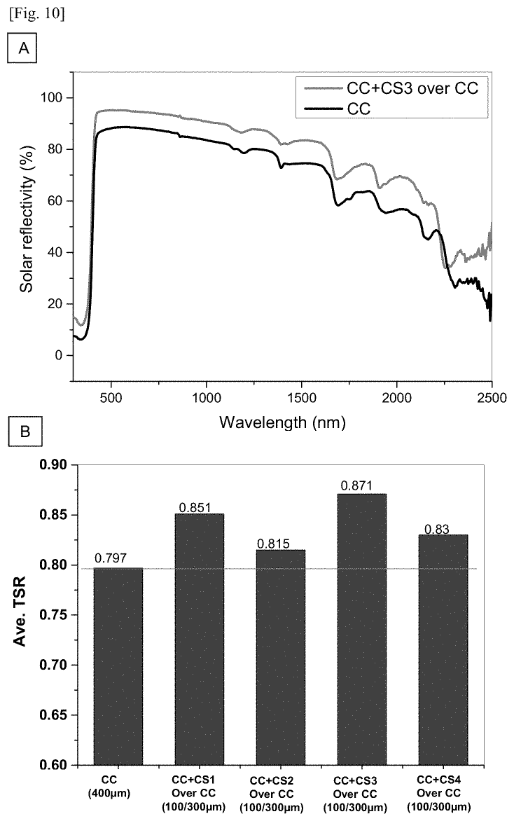

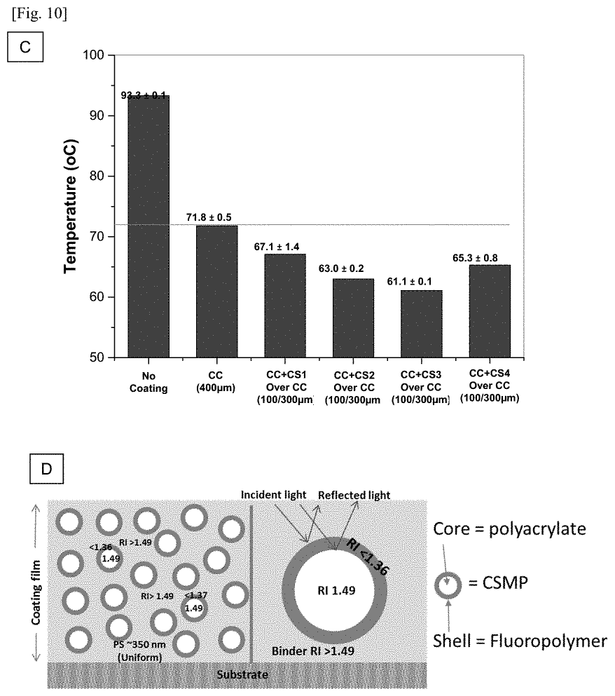

Another approach adopted in the coating experiment was top layer approach by considering efficient utilization of CSMPs. In this methodology, a thin layer of CSMP modified CC of about 100 μm was applied on the CC-coated steel coupon. The TSR values of coating films of similar thickness were then compared. Similar observation as previously found was obtained. For all cases of CSMP modified CCs, which were applied as top layers, the CSMP modified CCs-coated coupons exhibit significant improvement in TSR values (refer to FIGS. 10a, 10b, 10c and Table 3).

TABLE 3
The variation of TSR and surface temperature with the
coating thickness and various inventive dispersion of
the present invention when top layer method was used

| | Average | Average | |
|---|---|---|---|
| | thickness of | Total Solar | Surface |
| | coating film | Reflectivity | temperature |
| Sample | (μm) | (TSR) | (° C.) |
| No coating (only steel | — | — | 93.3 ± 0.1 |
| coupon used as substrate) | | | |
| Steel coupon coated with | 400 | 0.797 | 71.8 ± 0.5 |
| CC | | | |
| Steel coupon coated with | CC ≈ 300 | 0.851 | 67.1 ± 1.4 |
| (CC + CS1) over CC | (CC + CS1) ≈ | | |
| | 110 | | |
| Steel coupon coated with | CC ≈ 300 | 0.815 | 63.0 ± 0.2 |
| (CC + CS2) over CC | (CC + CS2) ≈ | | |
| | 120 | | |
| Steel coupon coated with | CC ≈ 300 | 0.871 | 61.1 ± 0.1 |
| (CC + CS3) over CC | (CC + CS3) ≈ | | |
| | 120 | | |
| Steel coupon coated with | CC ≈ 300 | 0.83 | 65.3 ± 0.8 |
| (CC + CS4) over CC | (CC + CS4) ≈ | | |
| | 120 | | |

The increase in TSR of the CSMP modified CCs is likely due to the combination of the following factors:
i) The presence of homogenously distributed spherical CSMPs. As evidenced by the light scattering analysis, the CSMPs modified CCs are homogenously distributed and there was no aggregation detected;
ii) The microparticle nature of the core-shell additives having the particle size of about 300 to 400 nm, which falls within the required size of most intense wavelengths (400 to 1350 nm) in solar spectrum. Previous studies suggest that the particle size in the range of ⅓ to ½ of the incident wavelength are well suited to achieve high reflectivity and increased diffraction;
iii) Increased refraction and diffraction due to the mismatch of the refractive index (RI) between matrix and CSMPs. The acrylate binder has RI of about 1.489 and the RI of fluoropolymer used in the shell is about 1.36;
iv) Significant increase in grain boundary area due to core-shell nature, which is approximated about twice as much as using a homogeneous particle (refer to FIG. 10d)

### Example 5: Dirt Removal Properties of CSMP Modified CCs (Wet Deposition/Wet Removal)

Fluorinated polymers are well-known for their omniphobic properties. Owing to its low surface energy, a fluorinated surface reduces interaction with water, oil or any other contaminants including dirt, which is composed of a combination of different components with different structure and polarity.

Being a microparticle with large surface area and due to the presence of fluoropolymer in the very thin shell component, these microparticle additives maximize the improvement of these properties by utilizing small amount of otherwise expensive fluoromonomers. The fluorinated CSMP additives were prepared according to Example 1, via emulsion polymerization in water and were well compatible with water based commercial coatings as shown in Example 2.

a. Wet Soiling (Dirt-Deposition) Experiment

The wet soiling experiment mimic the natural dirt-deposition process where rain drops transport the airborne particles onto the roof surface and then evaporated out leaving behind the particles on the surface. Real dirt used was collected from air-conditioning inlet system and was used for evaluation.

The above real dirt was characterized by different analytical techniques and was shown to contain a complex mixture of organic, inorganic, hydrophilic and hydrophobic components. The experimental overview of the wet soiling (dirt-deposition) is illustrated in FIG. 11a. Firstly, the real dirt was dispersed into the deionized water, followed by loading of the soiled liquid (step 4) onto silicone sealed coupon to afford soiled substrate 24. Step 4 using dry soiling method is described in Example 6a. The coupon was then dried in the oven. This methodology allows the loading of exact designated amount of dirt onto the coupons surface. Following this step, soiled substrate 24 undergoes a wash-off or dirt removal step 6 described in part b below to afford washed substrate 26.

b. Dirt Wash-Off (Dirt-Removal) Experiment

In this experiment, rainfall of 82.8 L/m² h was used to replicate the flash flooding rainfall intensity. In addition to considering the intensity of rainfall, another parameter used was the amount of water fall that the coupons were exposed to. The reference point was the average rainfall which was 2217 mm (2217 L/m²). Calculation showed that 26.8 L of spraying is proportional to a monthly rainfall. Therefore, the samples would be exposed to rain in the box for two hours and 14 minutes at a flow rate of 12 L/h to simulate an equivalent exposure of a month long of flash flooding rainfall. A complete cycle of the wash off experiment will be a study for spraying of 3 month equivalent of flash flooding rainfall.

Steel coupons coated CC and CSMP modified CC were used to evaluate dirt-removal performance and the experimental. The experimental design is depicted in FIG. 11b.

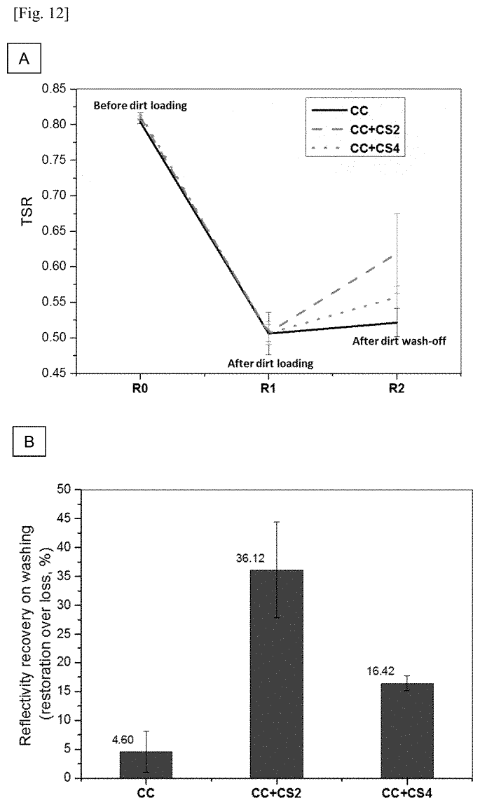

Solar reflectivity was used to quantify dirt loading and wash off. The linear relationship between solar reflectivity and dirt amount has been established previously. The dirt-removal results are shown in FIG. 12a. As can be seen, the CSMP modified has improved dirt-removal properties than CC, which was used as reference. The actual extent of wash-off recovery of the CSMP modified CCs was dependent on the type of CSMP additive used, particularly the type of fluoropolymer shell present in the CSMPs. The results reveal that CS2 and CS4 were the best additives among all CSMPs. From FIG. 12b, it is shown that CSMP modified CC with CS2-type of core-shell structure has best dirt-wash-off recovery (up to about 36%, refer to FIG. 12b). This is most probably due to the high glass translation temperature (T_{g}) of shell composition.

The reflectivity restoration over loss in percent (or %) may be defined as the ratio of the restored reflectance by washing (R2-R1) with respect to lost reflectance by soiling (R0-R1), where:

R0=Reflectance of coupons before dirt loading;

R1=Reflectance of coupons after dirt loading;

R2=Reflectance of coupons after dirt wash-off;

R0, R1 and R2 were measured according to step 8 of FIG. 11A. The formula to calculate the reflectivity restoration over loss is shown below:

$$Reflectivity restoration over loss ( \% ) = \frac{Restored reflectance by washing ( R 2 - R 1 )}{Lost reflectance by soiling ( R 0 - R 1 )} \times 100$$

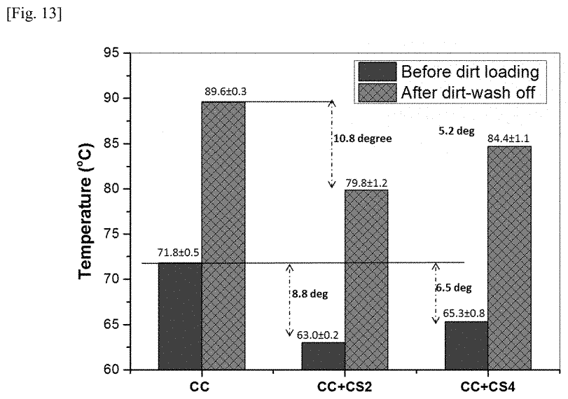

The selected dirt-washed off coupons (CS2 and CS4 modified CCs) were tested for heat build-up measurements and the results are shown in FIG. 13. Overall, the CS2 modified CC coated coupons maintained the less heat build-up properties than the pure CC coated coupons.

### Example 6: Dirt Removal Properties of CSMP Modified CCs (Dry Deposition/Wet Removal)

a. Dry Soiling (Dirt-Deposition) Method

The dry soiling was undertaken inside a customized dry deposition chamber. The chamber was made of stainless steel and had the inner dimensions of 60 cm (W)×60 cm (H)×60 cm (L). Four mixing fans (Paps, Series 8000N), each providing 50 cm³/h of airflow rate were installed inside the chamber to provide air mixing. The above chamber was also equipped with a circular inlet port at the centre of the chamber through which the dirt particles were introduced.

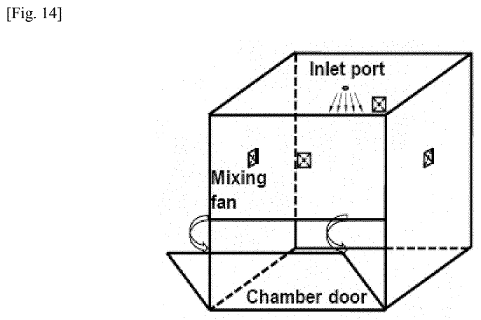

The set-up of the above experiment is depicted in FIG. 14.

The fans in the chamber were operated for five minutes prior to the onset of the experiment to ensure that a fully turbulent air flow condition was generated within the chamber. A funnel with fine cloth sieve having opening size of 100 □m was placed in the inlet port of the deposition chamber. The weight ball milled particles was introduced into the dry soiling chamber via a fine cloth sift (opening size of 100 □m) with shaking over the period of three minutes. The fans were switched off five minutes after the loading to allow the particles to settle. Pre-weighed coupons were retrieved after two hours and sent for TSR and weight measurement.

b. Dirt Wash-Off/Recovery (Dirt-Removal) Experiment of Dry Soiled Coupons

The dry soiled coupons were then subjected to similar wash off recovery (dirt-removal) described in Example 5b (refer to FIG. 11b).

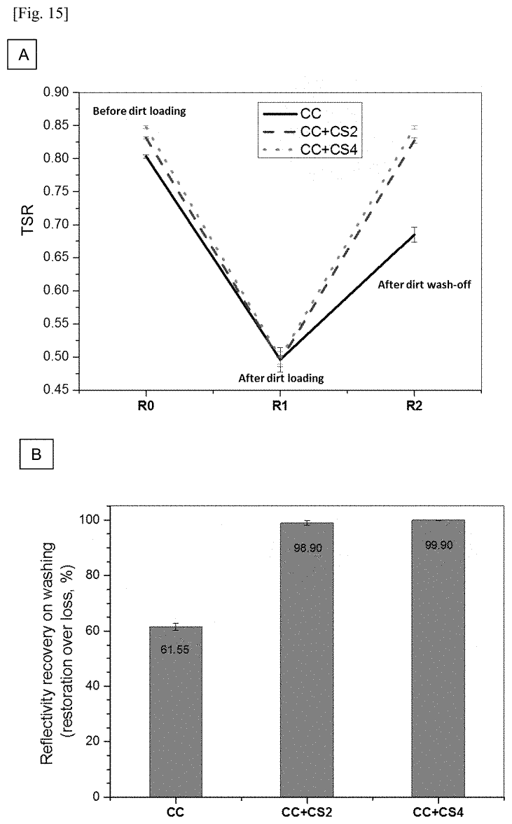

With reference to FIG. 15a, the experimental results suggest that the CS2 and CS4 modified CC exhibit improved dirt-removal properties compared to the pure CC. CS4 modified CC was able to achieve up to 100% recovery in comparison to the original CC, which could only recover 60% of its initial reflectance (refer to FIG. 15b). Further, the performance of CS2 modified CC is comparable to the CS4 modified CC.

### INDUSTRIAL APPLICABILITY

As shown above, the dispersion of the present invention is highly compatible with the parent coating material. As such, the dispersion described herein may be used as an additive. Further, since the dispersion described herein are omniphobic and have low surface energy, the coating comprising the dispersion therein may be used in various applications such as non-stick coating for cookware, bake-ware and electric appliance industry.

Further, as stated above, the coating may also be applied for roof coating (termed as cool roof), where cool roof can benefit a building and its occupants by: reducing energy consumption by decreasing air conditioning requirements, improving indoor comfort for spaces that are not air conditioned, such as garages or covered storage room as well as decreasing roof temperature, which may extend roof service life. Beyond the building itself, cool roofs may also benefit the environment, especially when many buildings in a community have them. Some of the advantages include reducing the local air temperatures, lowering the peak electricity demand, which in turn may help in preventing power outages, reducing power plant emissions, including carbon dioxide, sulfur dioxide, nitrous oxides, and mercury, by reducing cooling energy use in buildings.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A dispersion comprising
a. a plurality of core-shell particles, wherein the core comprises at least one non-fluorinated polymer and the shell comprises at least one shell layer having at least one fluorinated polymer or fluorinated copolymer therein; and
b. a solvent;
wherein said dispersion has a solid content of the core-shell particles of at least 10 wt %.

2. The dispersion of claim 1, wherein said shell comprises a fluorinated copolymer of at least two fluorinated monomers in the same shell layer.

3. The dispersion of claim 1, wherein said fluorinated polymer or fluorinated copolymer comprises a fluoroalkyl monomer with at least one of an acrylate monomer or a methacrylate monomer, or mixtures thereof.

4. The dispersion of claim 3, wherein said fluorinated polymer is selected from the group consisting of poly(2,2,2-Trifluoroethyl Acrylate), poly(2,2,2-Trifluoroethyl Methacrylate), poly(2,2,3,3-Tetrafluoropropyl Acrylate), poly(2,2,3,3-Tetrafluoropropyl Methacrylate), poly(2,2,2,3,3-Pentafluoropropyl Acrylate, poly(2,2,2,3,3-Pentafluoropropyl Methacrylate, poly(2,2,3,4,4,4-Hexafluorobutyl Acrylate), poly(2,2,3,4,4,4-Hexafluorobutyl Methacrylate), poly(2,2,3,3,4,4,4-Heptafluorobutyl Acrylate), poly(2,2,3,3,4,4,4-Heptafluorobutyl Methacrylate), poly(2,2,3,3,4,4,5,5-Octafluoropentyl Acrylate), poly(2,2,3,3,4,4,5,5-Octafluoropentyl Methacrylate), poly(3,3,4,4,5,5,6,6,7,7,8,8,8-Tridecafluorooctyl Acrylate), poly(3,3,4,4,5,5,6,6,7,7,8,8,8-Tridecafluorooctyl Methacrylate), poly(1H,1H-Perfluorooctyl Acrylate), poly(1H,1H-Perfluorooctyl Methacrylate) poly(3,3,4,4,5,5,6,6,7,7,8,8,9,9,10,10,10-Heptadecafluorodecyl Acrylate), poly(3,3,4,4,5,5,6,6,7,7,8,8,9,9,10,10,10-Heptadecafluorodecyl Methacrylate), poly(3,3,4,4,5,5,6,6,7,7,8,8,9,9,10,10,11,11,12,12,12-Heneicosafluorododecyl Acrylate), poly(3,3,4,4,5,5,6,6,7,7,8,8,9,9,10,10,11,11,12,12,12-Heneicosafluorododecyl Methacrylate, and mixtures thereof.

5. The dispersion of claim 3, wherein said fluorinated copolymer comprises at least two monomers selected from the group consisting of 2,2,3,4,4,4-Hexafluorobutyl Acrylate, 2,2,3,4,4,4-Hexafluorobutyl Methacrylate, 3,3,4,4,5,5,6,6,7,7,8,8,8-Tridecafluorooctyl Acrylate, 3,3,4,4,5,5,6,6,7,7,8,8,8-Tridecafluorooctyl Methacrylate, 1H,1H-Perfluorooctyl Acrylate, and 1H,1H-Perfluorooctyl Methacrylate.

6. The dispersion of claim 1, wherein the solvent is an aqueous solvent.

7. The dispersion of claim 1, wherein the core-shell particles have an average particle size in the range of 50 nm to 800 nm.

8. The dispersion of claim 1, wherein the core-shell particles have an average shell thickness in the range of 5 nm to 50 nm.

9. The dispersion of claim 1, wherein the solid content of the dispersion is in the range of 35% to 60%.

10.-19. (canceled)

20. A method of increasing total solar reflectance (TSR) of a substrate comprising the step of forming a coating of a mixture of a dispersion with a coating material on a surface of said substrate, wherein said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10% of the dispersion.

21. The method of claim 20, wherein said coating has a thickness in the range of 50 nm to 500 μm.

22. The method of claim 20, further comprising the step of heat treating the coating.

23. The method of claim 20, wherein the coating formed on the substrate is capable of repelling dirt.

24. A coated article comprising a layer of a dispersion coated thereon, said dispersion comprises a solvent with a plurality of core-shell particles disposed therein, said core-shell particles having at least one non-fluorinated polymer in the core and at least one fluorinated polymer or fluorinated copolymer in at least one shell layer of the shell, and said core-shell particles forming a solid content of at least 10% of the dispersion.

25. The coated article of claim 24, wherein said coated article is capable of reflecting solar light and repelling dirt.
